(19) United States
(12) Patent Application Publication
(10) Pub. No.: US 2012/0182886 A1
(43) Pub. Date: Jul. 19, 2012

(54) Method and Apparatus for Wireless Medium Access

(75) Inventors: Eng Hwee ONG, Singapore (SG); Jarkko Kneckt, Espoo (FI); Mika Kasslin, Espoo (FI)

(73) Assignee: Nokia Corporation

(21) Appl. No.: 13/006,823

(22) Filed: Jan. 14, 2011

(51) Int. Cl. H04L 12/26; H04W 84/02; H04W 4/00

(52) U.S. Cl. 370/252; 370/328; 370/338

(57) ABSTRACT

In a non-limiting and example embodiment, a method is provided for arranging multi-channel wireless communications, including detecting, by a communications apparatus, information on available bandwidth for a transmission opportunity applying multiple channels, and controlling duration of channel occupancy for at least one of channels available for the transmission opportunity on the basis of the information on available bandwidth.

### FIELD

The non-limiting example embodiments of this invention relate generally to arranging access to wireless medium, and more specifically to arranging wireless medium access in wireless networks with multi-channel capabilities.

### BACKGROUND

Various techniques exist for wireless networks to differentiate between data flows having different quality of service (QoS). For example, medium access control (MAC) layer may be provided with techniques to prioritize wireless medium access for delay-sensitive traffic. Some wireless communications technologies enable to selectively use one or more radio channels to vary data transmission rate.

### SUMMARY

Various aspects of examples of the invention are set out in the claims.

According to a first embodiment, there is provided a method, comprising: detecting, by a communications apparatus, information on available bandwidth for a transmission opportunity applying multiple channels, and controlling duration of channel occupancy for at least one of channels available for the transmission opportunity on the basis of the information on available bandwidth.

According to a second embodiment, there is provided an apparatus comprising at least one processor and at least one memory including computer program code, the at least one memory and the computer program code configured to, with the at least one processor, cause the apparatus at least to: detect information on available bandwidth for a transmission opportunity applying multiple channels, and control duration of channel occupancy for at least one of channels available for the transmission opportunity on the basis of the information on available bandwidth.

The invention and various embodiments of the invention provide several advantages, which will become apparent from the detailed description below.

### BRIEF DESCRIPTION OF THE DRAWINGS

For a more complete understanding of example embodiments of the present invention, reference is now made to the following descriptions taken in connection with the accompanying drawings in which:

FIG. 1 illustrates a wireless communication system;

FIG. 2 illustrates multi-channel communications events;

FIG. 3 describes a method according to an embodiment;

FIG. 4 illustrates examples of bandwidth-specific transmission opportunity limits;

FIG. 5 illustrates a method according to an embodiment;

FIGS. 6a and 6b illustrate multi-channel transmission opportunity examples;

FIG. 7 illustrates a method according to an embodiment;

FIG. 8 illustrates a method according to an embodiment;

FIG. 9 illustrates a channel access parameter record;

FIGS. 10a to 10e illustrate an information element according to an embodiment;

FIG. 11 illustrates bandwidth-specific transmission opportunity limit examples;

FIGS. 12a and 12b illustrate examples of TXOP duration measurements;

FIG. 13 illustrates an example of a communications event using multiple channels;

FIGS. 14a and 14b illustrate examples of TXOP duration measurements;

FIGS. 15 and 16 illustrate examples of communications events using multiple channels; and

FIG. 17 illustrates an apparatus according to an embodiment.

### DETAILED DESCRIPTION

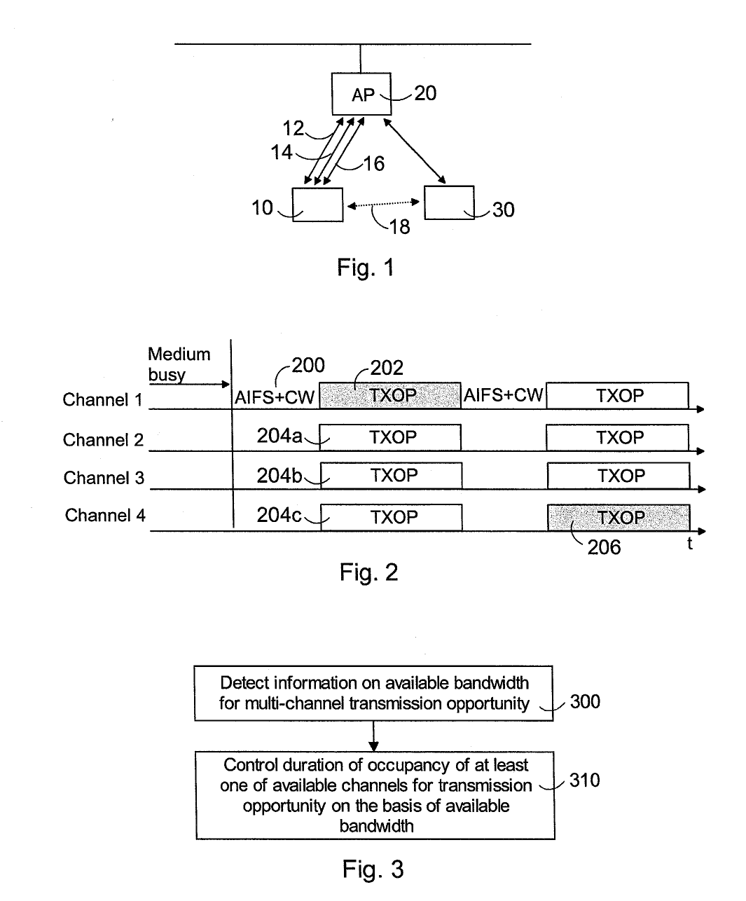

FIG. 1 illustrates an example of a wireless communication system including elements contending for network resources, such as elements supporting IEEE 802.11 features. However, it will be appreciated that the application of the present features is not limited to any specific network type(s), such as IEEE 802.11 based networks. It may be applied to other current or future networks, in which the transmission between two entities may be carried on one or more secondary channels in addition to a primary channel.

Wireless devices 10, 30 may associate with an access point (AP) or base station. In some embodiments, the devices 10, 30 are IEEE 802.11 WLAN stations (STA). In one embodiment the wireless device 10, 30 is capable of operating as a mesh node, such as a mesh node operative according to IEEE 802.11s. In a further example embodiment the wireless device 10, 30 is capable to operate 18 in independent BSS (IBSS), and operate according to principles of IBSS network, whereby no AP 20 is involved.

The wireless device 10 may be capable of communicating via zero or more secondary channels 14, 16 in addition to a primary channel 12 defined for the device 10. In IEEE 802.11 based WLAN, a primary channel is a frequency channel in which a WLAN STA performs contention-based access to the wireless medium and in which it may receive transmissions. In some embodiments the device 10 is capable of operating under multi-channel features being developed by the IEEE 802.11ac working group. Channel bandwidths between 20 MHz (single channel) to 160 MHz are currently being discussed. However, it will be appreciated that the present features may be applied in connection with other multi-channel access techniques.

The basic 802.11 MAC layer uses the distributed coordination function (DCF) to share the medium between multiple stations 10, 30. The DCF relies on carrier sense multiple access with collision avoidance (CSMA/CA) and handshaking with request to send (RTS) and clear to send (CTS) frames to share the medium between stations. However, the DCF does not result in a mechanism to differentiate the channel access rules between stations or their traffic.

The IEEE 802.11e is an extension of the IEEE 802.11 to provide Quality of Service (QoS) for applications requiring real-time services. It is divided into two parts: Enhanced distributed channel access (EDCA) and hybrid coordination function controlled channel access (HCCA). In EDCA there are eight traffic categories (TC) that are mapped to four access categories (AC). Each AC has its own transmission queue. A station with high priority traffic waits a little less before it sends its packet, on average, than a station with low priority traffic. The concept of transmission opportunities (TXOPs) was introduced in the 802.11e amendment to increase the transmission efficiency of the traffic belonging to the same AC. A TXOP is a bounded time interval in which a STA that has obtained the TXOP, i.e. a TXOP holder, maintains the right to transmit data, control, and management frames of a particular AC so long as the duration of frame sequence does not exceed the TXOP limit of that AC. During EDCA, an EDCA parameter set determines the channel access. The EDCA parameter set creates the differentiation between ACs. The EDCA parameter set has five parameters: The Access Category Indicator, The content window (CW) minimum and maximum, the an arbitration interframe space (AIFS) and the TXOP limit. The TXOP limit indicates the maximum duration during which the station is allowed to transmit. The current TXOP limit defines the TXOP limit for legacy 802.11n and 802.11a/g devices, and 802.11ac transmissions to 20 MHz bandwidth.

Each STA 10 may be arranged to define TXOPs in its own primary channel. In the example of FIG. 2, channel 1 represents the primary channel for a user. A TXOP 202 may begin after AIFS time and a contention window (CW) period 200 defining the backoff period.

If at least one secondary channel is idle, the STA may transmit 204a, 204b, 204c on at least one secondary channel (channels 2 to 4) for wider bandwidth operation to increase data rate. As further illustrated, (another user) may start a multi-channel transmission in another primary channel 206 and other secondary channels only after the first multi-channel transmission. If multiple channels are applied for transmission in a given TXOP, such TXOP may also be referred to as multi-channel TXOP.

The current application of TXOP parameters is however not optimal for multi-channel operations, such as operations developed for the IEEE 802.11 ac. There is a single TXOP limit specified for an AC, whereby the TXOP limit will be the same for primary 202 and non-primary (secondary) 204a-c channels for transmitting data of a particular AC. Hence, the TXOP limit on secondary channels will follow the TXOP limit on the primary channel. Thus, a TXOP holder capable of using multiple channels may reserve unnecessarily long TXOPs, resulting in inefficient use of radio resources.

According to example embodiments of the invention, and as illustrated also in FIG. 3, information on bandwidth available for a multi-channel TXOP is obtained 300. This information may be received on the basis of results of channel sensing after obtaining a TXOP, for example. Thus, the information on available bandwidth may be obtained on the basis of number of channels detected to be idle in the network the device 10, 30 is associated to. A controller entity managing channel usage and performing at least the features of FIG. 3 may receive this information from a lower protocol layer entity, for example.

Duration of occupancy of at least one of available channels for the TXOP is controlled 310 on the basis of the information on available bandwidth. Thus, one or more values for parameter(s) affecting or defining the duration of channel occupancy may be defined for at least one of the available channels on the basis of amount of available bandwidth for the TXOP. Such bandwidth-dependent TXOPparameter value may be calculated on the basis of input value(s) associated with the currently available bandwidth, or a value associated with the currently available bandwidth may be selected amongst a set of predefined values. The term ‘transmission opportunity’ or TXOP is to be understood broadly to be initiated by a random channel access operation or at a scheduled time instance after which messages may be transmitted and received. TXOPs cover any type of guaranteed or non-guaranteed channel access event, without limiting the definition only to TXOPs of the IEEE 802.11 based systems. Although references are made below to IEEE 802.11 based entities and features, it will be understood that the present features related to controlling channel occupancy based on available bandwidth may be applied in other wireless systems.

A value specifying the expected duration of the TXOP and/or a time limit for the TXOP may be calculated for at least one of the available channels on the basis of the information on available bandwidth in block 310. The term ‘TXOP limit’ as applied herewith refers generally to a time limit parameter specifying the maximum allowed duration of a TXOP, e.g. similarly to the IEEE 802.11e TXOP Limit parameter. A device may estimate the expected TXOP duration prior it starts the TXOP. Such expected TXOP duration value may be sent for other radio devices to indicate the channel occupancy.

In case of IEEE 802.11e based WLAN, the TXOP holder maintains uninterrupted control of the medium during the TXOP. The TXOP holder may protect the duration that it will maintain the medium occupied for it by setting the network allocation vector (NAV). The expected TXOP duration may be included in a duration field of a request to send (RTS) message. When a CTS message is received for the RTS, the NAV protection is established on all the channels that carried these messages and the operation in each specific channel is fully compatible with existing 802.11 systems. In some example embodiments, the elapsed TXOP duration and the protected duration (NAV) shall be less or equal to the bandwidth-dependent TXOP limit. The medium occupancy of secondary channels for the TXOP may be measured separately, and the maximum duration that these secondary channels may occupied during the TXOP may be limited by own dedicated TXOP limits. The (maximum) duration of a TXOP may thus be limited in response to secondary channel(s) being available. This allows faster release of secondary channels for other primary users and enables to improve bandwidth usage efficiency.

Such bandwidth-dependent TXOP parameter values may be specified separately for each available channel detected to be idle. In alternative embodiments, a single parameter value calculated based on the currently available bandwidth is applied for a plurality of available channels.

A TXOP holder, such as the wireless device 10, which in some embodiments operates as an IEEE 802.11ac capable non-AP STA, may be arranged to define bandwidth-dependent TXOP parameter values for each of the applied channels and control 310 the channel occupancies on the basis of these TXOP parameter values. In some cases a QoS capable AP 20 may be arranged to define bandwidth-dependent TXOP parameters and provide them for TXOP holders.

Bandwidth-Dependent TXOP Limits

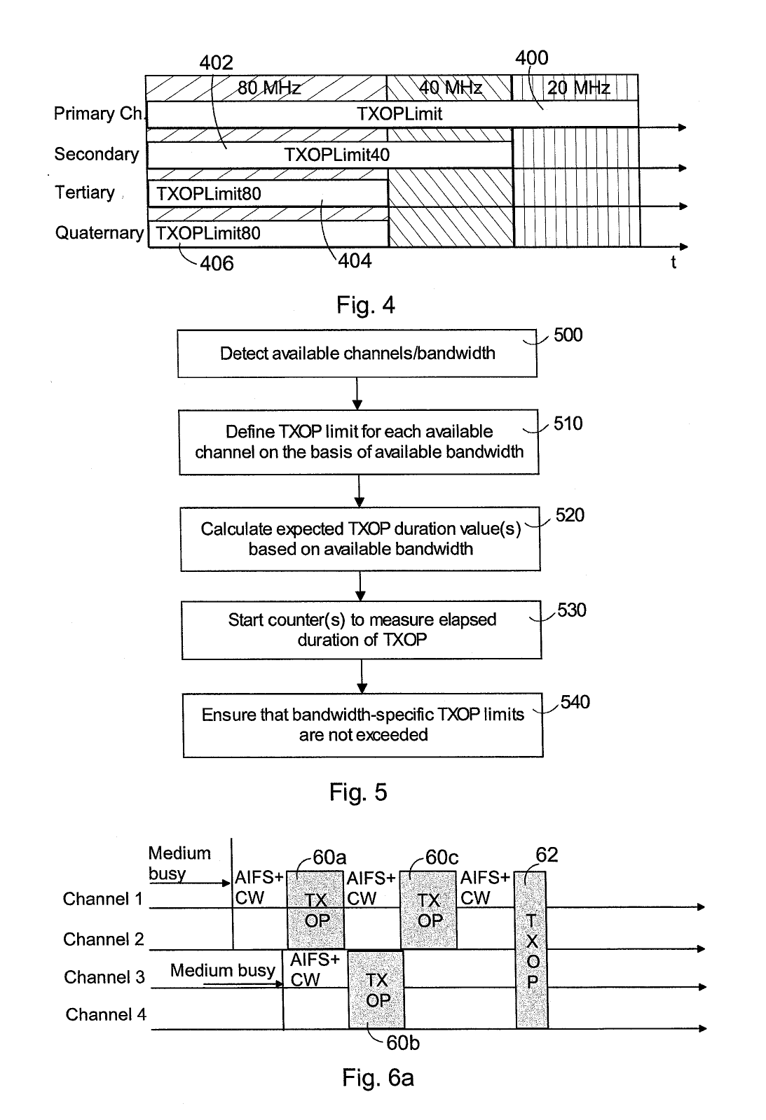

Further example embodiments for applying bandwidth-dependent TXOP limits are now further provided. FIG. 4 provides an example of bandwidth-dependent TXOP limits. One or more 20 MHz channels may be applied, and a specific TXOP limit is defined for 20 MHz bandwidth 400 (only primary channel is applied), 40 MHz bandwidth 402 (primary and secondary channel), and 80 MHz bandwidth 404, 406 (also tertiary/quaternary channel). These bandwidth-specific TXOP limits may define for each channel the maximum time the channel may be occupied at a TXOP: The primary channel may be occupied e.g. 3 ms (example value of TXOPLimit20), the secondary channel may be occupied for 2.25 ms (=TXOPLimit40), etc.

FIG. 5 illustrates a method for defining and applying bandwidth-specific TXOP limit parameters according to an embodiment. The features may be carried out by a TXOP holder, such as the device 10 operating as an IEEE 802.11ac STA, for example.

Currently available channels and bandwidth is detected 500. This block may be entered after receiving channel information from an access point 20 and in response to a need to initiate a multi-channel transmission event, for example. In case of 802.11 based transmission, block 500 may be entered e.g. after detecting a medium free after the AIFS and CW period. The available channels and bandwidth may be detected by performing the clear channel assessment (CCA) a point (coordination function) interframe space (PIFS) before the TXOP obtaining, i.e. the start of the TXOP. I.e. available channels may be idle channels to which RTS or data may be sent on the basis of sensing just prior to the TXOP initiation time. It is to be noted that the device 10 may in connection of block 500 decide to use only some of available channels and bandwidth, in which case the “available channel/bandwidth” below may refer to the channels/bandwidth which the device decides to use.

Bandwidth-specific TXOP limits, specifying the maximum duration for a multi-channel TXOP, are defined 510 on the basis of the information on available total bandwidth. The TXOP limits may be defined separately for each of the available channels for the TXOP, i.e. for a primary channel and zero or more secondary channels. For example, the device 10 may have received and stored bandwidth-specific TXOP limit parameter sets earlier, and the device 10 may define the TXOP limit values on the basis of the parameter values retrieved from the memory.

At least one value for expected TXOP duration may be calculated 520 on the basis of the available bandwidth. It is to be noted that TXOP durations may be calculated separately for each of the channels. Also the TXOP limits may be applied in the calculation, to ensure that a TXOP, the duration of which exceeds the channel-specific maximum values, is not allocated. At block 520 the device 10 may prepare multiple different versions of the frames that are going to be transmitted. For instance, the device may select different traffic to be transmitted by using different scheduling logics (i.e. to select the recipients and/or the content, stream or the type of the transmission), apply different transmission rates for the traffic to be transmitted and aggregate MPDUs and MSDUs to be transmitted by using different frame aggregation principles. With these preparations the device may discover the optimal transmission format for the traffic to be transmitted.

When the TXOP is started, at least one counter may be activated 530 to measure the duration of the elapsed TXOP, which may also be referred to as elapsed TXOP duration representing the already used time for the TXOP. The TXOP duration may be incremented whenever there is an ongoing transmission, regardless of the transmission bandwidth. However, the procedure ensures 540 that the bandwidth-specific TXOP limits are not exceeded. The procedure may ensure in block 540 that duration of the (total) medium occupancy within the TXOP, which may also be referred to as total TXOP duration, comprising already elapsed TXOP duration and estimated remaining TXOP duration, does not exceed the bandwidth-specific TXOP limit values. The remaining duration indicates the estimated further required time and may be calculated e.g. on the basis of amount of data still to be transmitted. For example, if the total TXOP duration reaches the TXOP limit 404 of FIG. 4 for 80 MHz operations, the transmission may be performed only on primary and secondary channels and thus by 40 MHz bandwidth.

The device 10 may sum the estimated remaining duration with the elapsed TXOP duration to estimate the total TXOP duration. The device 10 may compare the estimated total TXOP duration value to the TXOP limit value, and ensure that TXOP limit value is not exceeded. The comparison of the total TXOP duration value to the TXOP limit values may be performed at least in the beginning of the TXOP (e.g. when sending the first RTS) and when estimated total duration is increased or decreased. Some example triggers for this include: bandwidth is increased or decreased during a TXOP, or during a TXOP a need to transfer more data is detected.

It is to be noted that in case of IEEE 802.11 based WLAN, the total TXOP duration may include both the elapsed TXOP duration and the NAV protected future time. The medium occupancy under 802.11 includes both the time required for transmitting the RTS and the NAV duration. It is further to be noted that the calculation of (expected) TXOP duration value may refer to calculation of value for the estimated total TXOP duration (at the start of a TXOP) or the NAV duration. In case of the first frame of a TXOP, the NAV value may be equal to the remaining TXOP duration. Comparison of the total TXOP duration value to a TXOP limit value may be performed in connection with each RTS/CTS procedure. However, it is possible that such comparison is performed for each transmitted frame.

It is also noted that a remaining duration value, which may be included in each frame transmitted during the TXOP, may indicate the remaining time after transmitting the frame. In an example embodiment, in case a new RTS is sent during an ongoing TXOP, the duration field value of RTS is updated on the basis of the current situation. Hence, the RTS duration value may be adapted during the TXOP to be in view of the current bandwidth situation (more or less bandwidth may be available at the time of second RTS). The elapsed TXOP duration is not reset. The updated duration value for the RTS duration field summed with the elapsed TXOP duration value may not exceed the (channel-specific) TXOP limit.

It is to be noted that FIG. 5 illustrates only one example of setting and applying TXOP parameters on the basis of available bandwidth, and various amendments and additions may be made to this procedure.

The embodiment of FIG. 5 enables to use both channel-specific TXOP limits and define TXOP duration(s) on the basis of the available total bandwidth for the TXOP. In some other examples, only bandwidth-dependent channel-specific TXOP limits are allocated, or only bandwidth-dependent TXOP durations are calculated for each of the available channels. In the latter example variation, each secondary channel may have a different TXOP duration.

In case the channels need to be used in a predetermined order, e.g. the use order may be: primary, secondary, tertiary and quaternary for the 802.11ac, the lengths of TXOP limits should be assigned in the same order. Thus, the TXOP limit of the channels to be used together with the earlier channels shall not exceed the TXOP limit(s) of the previous channels. For instance, transmissions at tertiary and quaternary channels require transmission also at the primary and the secondary channels, so the TXOP limit for the tertiary and quaternary channels may be shorter than the limit for the primary and the secondary.

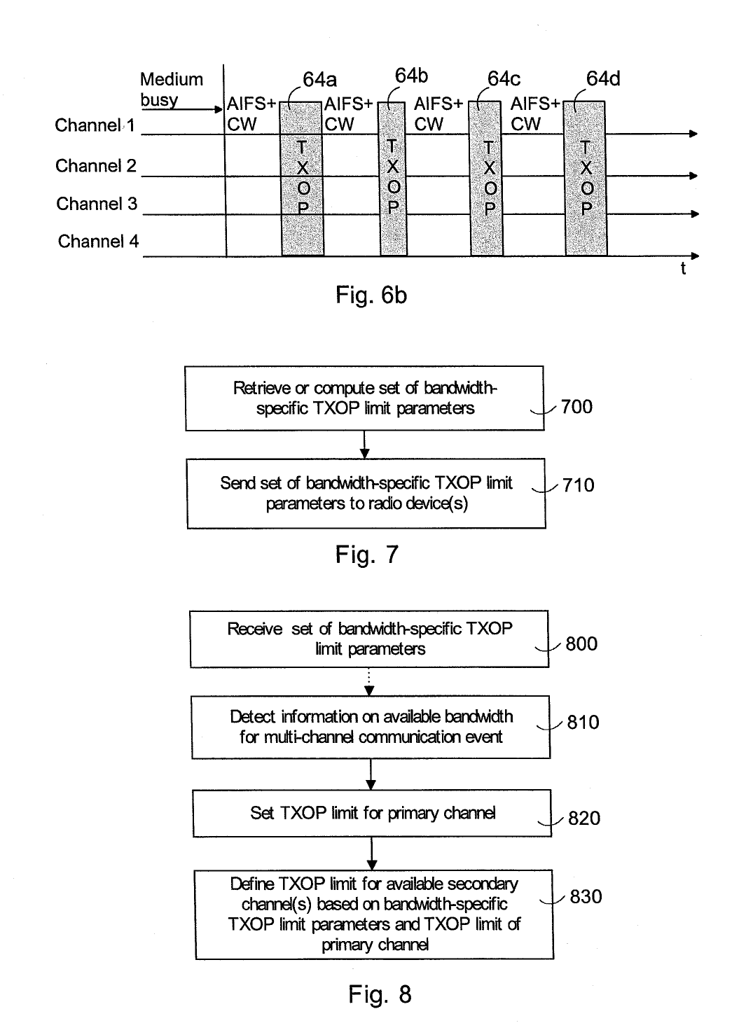

FIGS. 6a and 6b illustrate examples of multi-channel operations, in which the total TXOP durations are limited on the basis of the available bandwidth. In FIG. 6a both 40 MHz transmissions 60a-c and 80 MHz transmissions 62 are carried out, and in FIG. 6b 80 MHz transmissions 64a-d occupying all four example channels are applied. It is to be noted that the variation of the total TXOP durations reflects the load situation of a STA. As compared e.g. to the example of FIG. 2, when the 80 MHz bandwidth is applied, the total TXOP duration may be shortened, and the delays for other users accessing the channels can be reduced. The reduced airtime occupancy will increase the likelihood to capture the whole 80 MHz bandwidth during contention. This enables to improve the probability of operating with larger 40/80 MHz bandwidth enabling the use of higher data rates, lower MAC delay due to faster transmission of the data, and better fairness between different contending STAs. It also to be noted that FIGS. 6a and 6b illustrate contention between STAs of the same AC. The present features may be applied also for contention between STAs of different ACs. Let us now further study some example embodiments in more detail.

Bandwidth-Dependent TXOP Limit Definition

FIGS. 7 and 8 illustrate an embodiment by which bandwidth-dependent TXOP limit parameters may be co-ordinated and provided for TXOP holders in a network.

FIG. 7 illustrates features of an entity providing information on TXOP limits for TXOP holders. For example, the features of FIG. 7 may be applied in the AP 20, such as an IEEE 802.11ac WLAN access point.

At least one set of transmission opportunity limit parameters, each of the parameters being associated with specific bandwidth, is retrieved or computed 700. Thus, an AP 20 may apply predefined TXOP limit parameter values, or dynamically alter the TXOP parameter values e.g. on the basis of current load situation. The AP 20 may also consider the amount of overlapping further APs in its operating channels and reduce the use of overlapping channels to improve the co-existence of the networks. The AP may also receive the channel specific TXOP limit parameter values from a central unit that is mastering the performance and load balancing of the local area network.

It will be appreciated that there may be multiple sets of bandwidth-specific TXOP limit parameters, e.g. for each IEEE 802.11e AC to differentiate traffic flows with different QoS requirements. The set(s) of bandwidth-specific TXOP limit parameters are sent 710 to one or more radio devices.

FIG. 8 illustrates features for an entity capable of operating as a multi-channel TXOP holder, such as the device 10 which may operate as an IEEE 802.11ac STA. A set of bandwidth-specific TXOP limit parameters is received 800 and stored in memory. The set may be received from the AP 20 applying the features of FIG. 7, for example.

When there is a need to transmit and define properties of a TXOP, the stored TXOP limit information may be retrieved, e.g. after detecting 810 information on available channels and bandwidth.

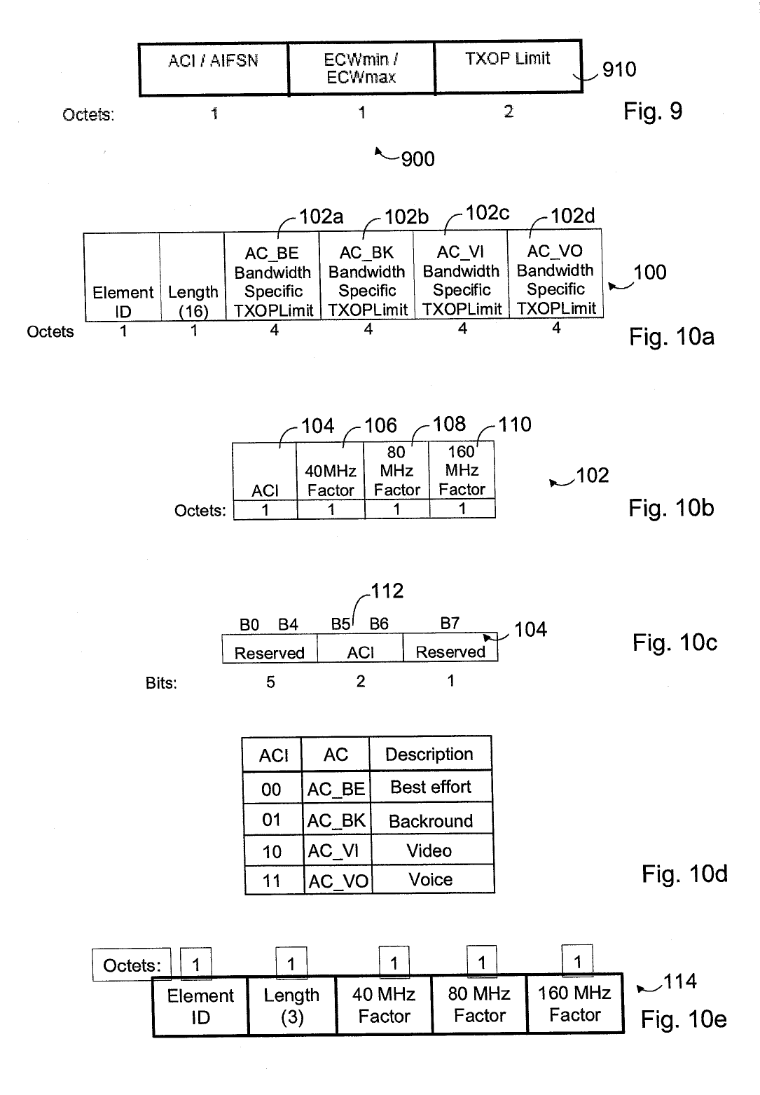

A TXOP limit is set 820 for the primary channel for a TXOP. In one example embodiment, a value for this primary channel TXOP limit is obtained from the “TXOP Limit” field 900 of the AC-specific EDCA parameter record 900 illustrated in FIG. 9.

In the example embodiment of FIG. 8, a TXOP limit may then be defined for each available secondary channel on the basis of the set of bandwidth-specific TXOP limit parameters and the TXOP limit of the primary channel. Thus, referring also to the example of FIG. 4, a TXOP limit value is defined for a secondary channel on the basis of a TXOP parameter associated in the set with bandwidth available by the respective secondary channel for the TXOP. For example, in case the Secondary channel of FIG. 4 is available, 40 MHz bandwidth is available and the TXOP limit value for the secondary channel is calculated on the basis of the TXOPLimit40. These channel-specific TXOP limit values may then be applied for controlling occupancy of the respective channels, e.g. as already indicated in connection with FIG. 5. In an example variation of FIG. 8, the TXOP limits for secondary channels are not dependent on the TXOP limit of the primary channel.

In an example embodiment, a new information element is specified for bandwidth-specific TXOP limit parameter information. As illustrated in the example element 100 of FIG. 10a, the information element may specify bandwidth-specific TXOP Limits parameter set 102a-d for each AC. FIG. 10b illustrates an example of contents of such parameter set 102. FIG. 10c depicts the access category identifier (ACI) field 104 indicating the AC and 10d the coding of the ACI value field 112.

As illustrated in FIG. 10b, the parameter set 102 may comprise bandwidth-specific factor values 106, 108, 110, in this example for 40 MHz band, 80 MHz band and 160 MHz band, respectively. Each of the factor values may be unsigned integer. The actual channel-specific TXOP limit values may then be calculated (510, 830) on the basis of these factor values and the TXOP limit of the primary channel.

For example, the value of 40 MHz factor 106 may be divided by 255 and multiplied by the duration of the TXOPLimit (representing the TXOP limit of the primary channel) to calculate the TXOPLimit40. A reference is also made to FIG. 4 illustrating such TXOP limit 402. This limits the medium occupancy of the 40 MHz or wider bandwidth transmissions. Value 0 in 40 MHz Factor may indicate that no transmission shall use 40 MHz or wider bandwidth. The value of 80 MHz factor 108 may be divided by 255 and multiplied by the duration of the TXOPLimit to calculate the TXOPLimit80 404 that limit the medium occupancy of the 80 MHz or wider transmissions. Value 0 in 80 MHz Factor may indicate that no transmission shall use 80 MHz or wider bandwidth. The value of 160 MHz Factor may similarly be divided by 255 and multiplied by the duration of the TXOPLimit to calculate the TXOPLimit160 that limits the medium occupancy of the 160 MHz or wider transmissions. Value 0 in 160 MHz Factor may be set to indicate that no transmission shall use 160 MHz bandwidth. The TXOP limit values may be rounded up to next multiple of 32 micro seconds.

In some embodiments there is no differentiation between ACs and a single set of TXOP limit parameters may be transmitted 710 and applied 830 by the device 10. FIG. 10e illustrates a further example information element 114 which may be used to deliver in such case. The information element comprises an element identifier, length information, and fields for bandwidth-specific factors.

The QoS capable AP 20 may be arranged to transmit (710) the bandwidth-specific TXOP limit parameter sets 100, 114 at the same time as the AC-specific EDCA parameter sets illustrated in FIG. 9. Thus, the AP 20 may be arranged to include the bandwidth-specific TXOP limit parameter sets 100 in Beacon frames, Probe Response frames, and (Re)Association Response frames by inclusion of a new information element comprising the bandwidth-specific TXOP limit parameters, e.g. by applying the example information element 100, 114. However, in an alternative embodiment the EDCA parameter set information element is modified to comprise the bandwidth-specific TXOP limit parameters. If no (applicable) bandwidth-specific TXOP limit parameters are received, the STA 10, 30 may be arranged to use a default TXOP limit value for the primary channel, or calculate bandwidth-dependent TXOP limit value(s) independently.

This embodiment enables to have compatibility with already specified EDCA parameters. The channel-specific TXOP limits can be used in conjunction with different AC specific EDCA parameters. It is to be noted that two different modes of operation are enabled: (i) channel specific TXOP limits with same EDCA parameters where service differentiation is controlled only by TXOP limits (airtime); and (ii) channel specific TXOP limits with different EDCA parameters where service differentiation is controlled by both TXOP limit (airtime) and AC specific EDCA parameters (prioritized channel access). Furthermore, the channel usage may be coordinated more specifically and in overlapping basic services set (OBSS) situations it becomes possible to tune the network performance more precisely.

Bandwidth-Dependent TXOP Parameter Calculation Examples

In one example, the TXOP limit of a STA i on channel jε[primary,secondary,tertiary,quaternary] may be computed (510) as the minimum of time required by the STA to transmit all MAC service data units (MSDUs) in its queue and time of a default AC's TXOP limit TX0Pₗᵢₘ[AC] given by

$${TXOP}_{i , j = primary} [ AC ] = min ( \frac{8 {\sum }_{k} {L}_{i}^{k} [ AC ]}{{R}_{j}} + O , {TXOP}_{lim} [ AC ] ) \qquad ( 1 )$$

where
k=number of MSDUs in the STA's queue,
Lᵢ^{k}[AC]=length of MSDU in a specific AC,
Rⱼ=PHY data rate of primary channel in bps,
O=physical layer (PHY) and MAC protocol overheads including duration of the interframe space and to transmit acknowledgment frames in time units.

The example expression (1) assigns the TXOP limit according to the load requirement of STAi up to the maximum duration allowed by the default TXOP limit of a specific AC. This ensures that no excess TXOP limit is assigned should the default TXOP limit of different ACs be non-optimal.

It is to be noted that the expression (1) can be readily replaced by some other TXOP limit calculation algorithm, which aims to allocate different airtimes for STAB with different QoS profiles based on some fairness criteria. Further, it is to be noted that the expected TXOP duration may be calculated (520) by applying an equation similar to (1).

In some example embodiments, common factor based TXOP limits are applied. A bandwidth increment factor ƒ reflecting the ratio of total available bandwidth and the bandwidth of the primary channel may be applied to calculate the TXOP limit values. The bandwidth increment factor ƒ can be simply expressed as

$$f = \frac{{BW}_{available}}{{BW}_{primary}} , {BW}_{available} = {\sum }_{j} {BW}_{j} \qquad ( 2 )$$

where
BW_{available}=total available bandwidth in MHz after CCA, and
BW_{primary}=bandwidth of primary channel in MHz.

The TXOP limit may then be calculated for each secondary channel by scaling the TXOP limit of the primary channel with the bandwidth increment factor ƒ given by

$${TXOP}_{i , j \neq primary} [ AC ] = \frac{{TXOP}_{i , j = primary} [ AC ]}{f} . \qquad ( 3 )$$

This enables to limit the transmission time of any given data frames by the bandwidth increment factor ƒ should multi-channel operation be possible.

The calculated expected TXOP duration value (based on channel-specific TXOP limits or a common factor) may then be applied to define the duration of the TXOP. In case of IEEE802.11e based WLAN, a STA may initiate multiple frame exchange sequences to transmit MMPDUs and/or MSDUs within the same AC during an EDCA TXOP won by an EDCA function (EDCAF) of the STA.

The TXOP duration value may be sent for other radio devices to indicate the channel occupancy. In the embodiment applying IEEE 802.11 features, the calculated duration of the TXOP is included in a duration field of a request to send (RTS) message. This enables network allocation vector (NAV) protection on secondary channels for primary users and is fully compatible with existing 802.11 systems. Protection against hidden terminals on secondary channels may thus be achieved without incurring additional signaling overheads for explicit channel reservation and relinquishment.

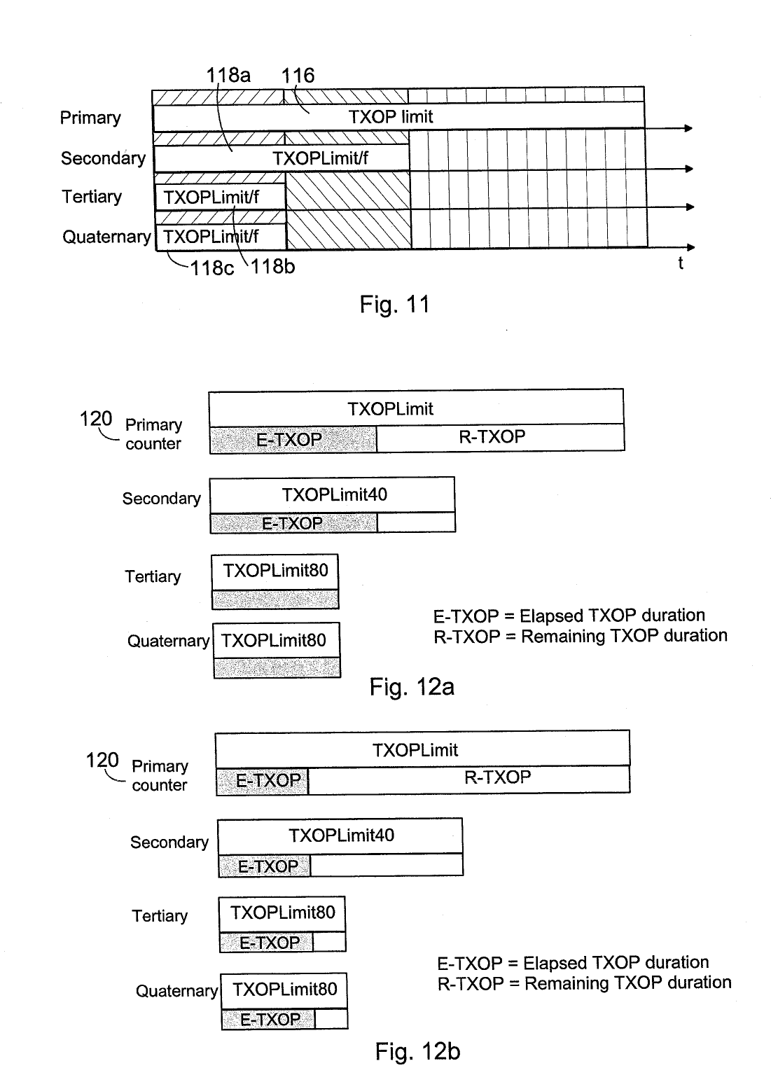

FIG. 11 illustrates examples of common factor based TXOP limits, where the TXOP limits 118a, 118b, 118c for the secondary channels are calculated on the basis of the TXOP limit 116 of the primary channel by expression (3).

Medium Occupancy During TXOP

As already indicated, the total TXOP duration may be estimated on the basis of measurements (530) during a TXOP by at least one counter. Below some example embodiments are provided for arranging the measurement (530) and ensuring (540) that the channel-specific TXOP limit values are not exceeded.

In some embodiments, single duration measurement is applied. Thus, the TXOP holder uses (530) a single counter when estimating the total duration of a TXOP. The total TXOP duration value may be incremented whenever the sum of elapsed duration and the future estimated remaining duration increases, regardless of transmission bandwidth. However, during the TXOP the TXOP holder ensures (540) that a specific channel may be occupied only if the total TXOP duration does not exceed the TXOP limit of the specific channel. If the total TXOP duration is larger than a TXOP limit value of a particular channel then during the TXOP that channel may no longer have NAV protection for TXOP holder and the channel may not transmit frames that belong to the TXOP.

For example, a TXOP can be associated with the following values:
Measured TXOP duration=1.2 ms
TXOPLimit=3 ms
TXOPLimit40=1.5 ms
TXOPLimit80=0.75 ms
TXOPLimit160=0.

This scenario is also illustrated in FIG. 12a. The TXOP holder may occupy only the bandwidths of 20 and 40 MHz (primary and secondary channels), but not the bandwidth of 80 MHz (tertiary and quarternary channels) as the measured TXOP duration has exceeded the TXOP limit of the tertiary and quaternary channels. The use of 160 MHz bandwidth is restricted by the value 0 of TXOPLimit160.

In another example, we may consider another scenario with the following values:
Measured TXOP duration=0.5 ms
TXOPLimit=3 ms
TXOPLimit40=1.5 ms
TXOPLimit80=0.75 ms
TXOPLimit160=0

This scenario is also illustrated in FIG. 12b. Now, the TXOP holder may now occupy the bandwidth of 20, 40, and 80 MHz (primary, secondary, tertiary, and quaternary channels) as the used TXOP duration has not exceeded any channel's TXOP limits. The use of 160 MHz bandwidth is restricted by the value 0 of TXOPLimit160. An advantage of this scheme lies in the simplicity of measurement of medium occupancy within TXOP, i.e. it may be implemented with just a single counter 120.

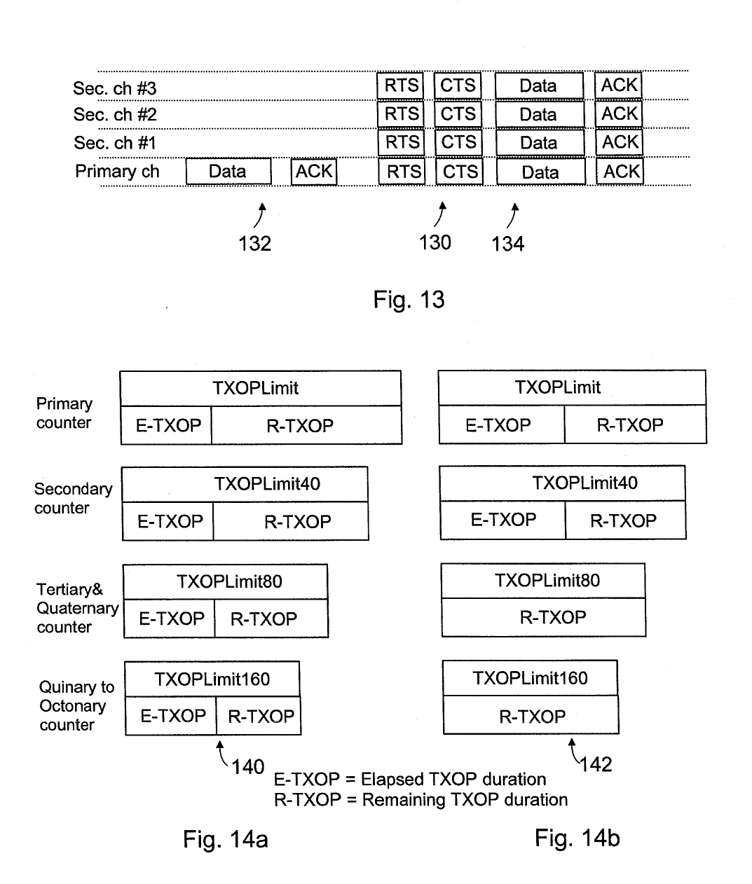

FIG. 13 illustrates bookkeeping of the TXOP duration in case of single duration measurement. In this example data are first transmitted on the primary channel, and then also the three secondary channels are reserved by the RTS/CTS signalling. The total TXOP duration may be increased 130 whenever the sum of elapsed and future estimated remaining durations increase, regardless of transmission bandwidth.

In some other example embodiments, the TXOP holder maintains multiple counters to enable estimation of the total TXOP duration and determines the total TXOP duration according to bandwidth occupancy. Thus, duration of the bandwidth occupancy may be measured for two or more combinations of channels. In one example for systems with 8 available channels, the following combinations of channels may be measured:
A. Measure the duration when TXOP holder occupies the primary channel
B. Measure the duration when TXOP holder occupies the secondary channel
C. Measure the duration when TXOP holder occupies the tertiary and quarternary channels
D. Measure the duration when TXOP holder occupies the quinary (5), senary (6), septenary (7), and octonary (8) channels

In the example of FIG. 14a, the transmission in 160 MHz means that the total TXOP durations of all primary (A), secondary (B), tertiary and quaternary (C), as well as quinary (5), senary (6), septenary (7), and octonary (8) (D) channels may be incremented 140.

Similarly, as illustrated in FIG. 14b, the transmission in 40 MHz bandwidth means that only the total TXOP durations of the primary (A) and secondary (B) channels may be incremented 142, but the total TXOP durations of the tertiary and quarternary (C), and quinary (5), senary (6), septenary (7), and octonary (8) (D) channels are not incremented.

Accordingly, the following rules may be applied for bandwidth-specific TXOP limits:
A. The duration when TXOP holder occupies the primary channel shall not exceed the TXOPLimit.
B. The duration when TXOP holder occupies the secondary channel shall not exceed the TXOPLimit40.
C. The duration when TXOP holder occupies the tertiary and quarternary channels shall not exceed the TXOPLimit80.
D. The duration when TXOP holder occupies the quinary (5), senary (6), septenary (7), and octonary (8) channels shall not exceed the TXOPLimit160.

These rules may be applied by the EDCAF to limit the wireless medium occupancy for each AC.

This embodiment facilitates flexibility of bookkeeping. The use of multiple counters enables the use of wider bandwidth later than just at the beginning of a TXOP, i.e. the transmission to larger bandwidth may be performed at any time during the TXOP. The total TXOP duration of options A, B, C and D is set for duration that the channel is occupied. With reference to the example of FIG. 13, when multiple timers are applied, the total TXOP duration of only the primary channel may be incremented at example point of time 132, and the total TXOP durations of all of used channels are incremented at point 134.

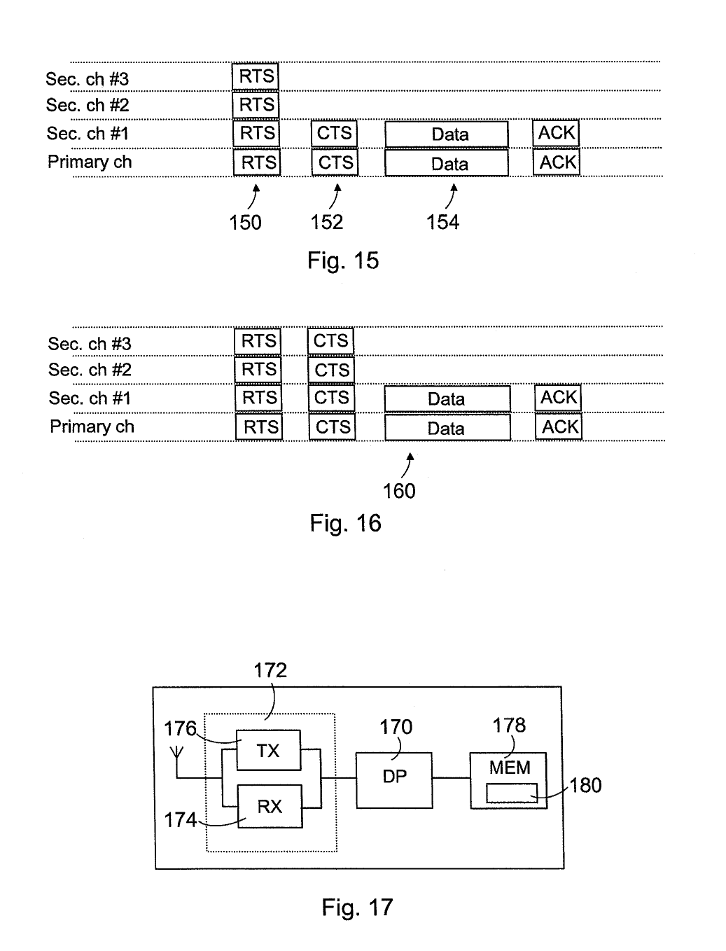

FIG. 15 provides a further example of TXOP duration bookkeeping when multiple duration measurements are performed and the RTS CTS signaling is not capable to reserve to requested bandwidth completely. The 80 MHz bandwidth is occupied until the transmission of the CTS reply is started 152. During the medium occupancy for RTS transmission and the following SIFS, the total TXOP durations for 20, 40, and 80 MHz are incremented 150. During the CTS and data transmissions, 40 MHz bandwidth is occupied and hence only the total TXOP durations for 20 and 40 MHz are incremented 154, i.e. the NAV protection is not established for the whole 80 MHz bandwidth.

FIG. 16 provides a further example of TXOP duration bookkeeping when multiple duration measurements are performed. The NAV is set by the RTS/CTS for the entire 80 MHz bandwidth. Although the TXOP holder uses only 40 MHz bandwidth for data exchange, the total TXOP durations for 20, 40 and 80 MHz are set for the duration 160, since all four channels are considered reserved for the TXOP holder.

In a still further example, in some cases an entity other than the TXOP holder, such as the AP 20 or a receiving entity, may be arranged to carry out at least some of the above illustrated features related to determining TXOP properties and channel occupancy duration on the basis of the bandwidth available for the TXOP. For example, the AP 20 may be arranged to adapt TXOP limits on the basis of the available bandwidth. Similarly, the AP 20 may monitor the behaviour of the devices 10, 30. If a device does not follow the channel specific TXOP limits, the AP 20 may disassociate the device and stop the data service.

FIG. 17 is a simplified block diagram of high-level elements of an apparatus according to an embodiment. The apparatus comprises a data processing element DP 170 with at least one data processor and a memory 178 storing a program 180. The apparatus may comprise at least one radio frequency transceiver 172 with a transmitter 176 and a receiver 174.

The memory 178 may comprise a volatile portion and non-volatile portion and implemented using any suitable data storage technology suitable for the technical implementation context of the respective entity. The data processing element 170 may be of any type suitable to the local technical environment, and may include one or more of general purpose computers, special purpose computers (such as an application-specific integrated circuit (ASIC) or a field programmable gate array FPGA), microprocessors, digital signal processors (DSPs) and processors based on a multi-core processor architecture, as non-limiting examples.

In general, various embodiments of the presently disclosed features may be implemented by computer software stored in a computer-readable medium, such as the memory 178 and executable by the data processing element 170 of the apparatus, or by hardware (such as an ASIC), or by a combination of software and/or firmware and hardware in the apparatus.

In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 17. A computer-readable medium may comprise a computer-readable storage medium that may be any media or means that can contain or store the instructions for use by or in connection with an instruction execution system, apparatus, or device, such as a computer.

The program 180 may comprise computer program instructions that, when executed by a data processor 170, enable the apparatus to operate in accordance with at least some embodiments of the present invention. The program may comprise computer program code configured to, with the at least one processor, cause the apparatus to perform at least some of the features illustrated in connection with FIGS. 3 to 16.

The apparatus could be in a form of a chip unit or some other kind of hardware module for controlling a radio device. The hardware module may form part of the device and could be removable. Some examples of such hardware module include a sub-assembly or an accessory device.

The apparatus of FIG. 17 may be arranged to use licensed and/or unlicensed bands. The apparatus may be arranged to support MIMO or multi-user MIMO and comprise a plurality of antennas and transceivers. The apparatus may be embodied as a mobile communications device. For instance, a mobile communications device such as the device 10, 30 of FIG. 1 may comprise the elements of FIG. 17. The apparatus may be configured to operate as an IEEE 802.11ac STA, AP, or mesh point. The apparatus is configured to arrange an EDCAF for each AC contending for TXOPs applying at least some of the above illustrated features. It should be appreciated that the above-illustrated embodiments provide only examples of some radio technologies in which the features related to applying adaptive transmission opportunity properties may be applied. However, in some other embodiments, the apparatus may operate according to a different communication protocol to the IEEE WLAN 802.11 protocols. It will be appreciated that the apparatus may comprise various further elements, such as further processor(s), further communication unit(s), user interface components, a battery, a media capturing element, and a user identity module, not discussed in detail herein.

Although the apparatus and the data processing element 170 are depicted as a single entity, different features may be implemented in one or more physical or logical entities. There may be further specific functional module(s), for instance for carrying one or more of the features described in connection with FIG. 3, 5, 7, or 8.

If desired, at least some of the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
detecting, by a communications apparatus, information on available bandwidth for a transmission opportunity applying multiple channels, and
controlling duration of channel occupancy for at least one of channels available for the transmission opportunity on the basis of the information on available bandwidth.

2. The method of claim 1, wherein a duration of medium occupancy within the transmission opportunity and/or a time limit for the transmission opportunity is calculated for at least one of the available channels on the basis of the information on available bandwidth.

3. The method of claim 1, wherein the apparatus is provided with access to a set of predetermined transmission opportunity limit parameters, further comprising
defining, for each available secondary channel, a transmission opportunity limit value on the basis of the transmission opportunity limit parameters and the information on available bandwidth.

4. The method of claim 3, wherein the set of predetermined transmission opportunity limit parameters comprises at least one bandwidth-specific factor for determining a transmission opportunity limit value for at least one secondary channel on the basis of a transmission opportunity limit value for a primary channel.

5. The method of claim 3, wherein the set of predetermined transmission opportunity limit parameters is received from another device in at least one of a probe response and a beacon message.

6. The method of claim 3, wherein the communications apparatus
determines the transmission opportunity limit for each of the secondary channels available for the transmission opportunity on the basis of the set of predetermined transmission opportunity limit parameters and a transmission opportunity limit of the primary channel,
estimates the total duration of channel occupancy during the transmission opportunity, and
ensures for each of the channels that the channel occupancy does not exceed the transmission opportunity limit determined for the channel.

7. The method of claim 6, wherein the occupancy of the primary channel and the occupancy of at least one secondary channel are defined on the basis of separate timers during the transmission opportunity,
the duration of the primary channel occupancy is prevented to exceed the transmission opportunity limit set for the primary channel, and
the duration of the at least one secondary channel occupancy is prevented to exceed the transmission opportunity limit set for the at least one secondary channel.

8. The method of claim 1, wherein a bandwidth increment factor is generated on the basis of ratio of available bandwidth and the bandwidth of the primary channel, and
a transmission opportunity limit is calculated for at least one secondary channel on the basis of a transmission opportunity limit of the primary channel and the bandwidth increment factor.

9. The method of claim 1, wherein expected duration of the transmission opportunity is calculated on the basis of the available bandwidth, and
the calculated duration of the transmission opportunity is included in a duration field of a request to send message.

10. An apparatus, comprising
at least one processor; and
at least one memory including computer program code,
the at least one memory and the computer program code being configured to, with the at least one processor, cause the apparatus at least to:
retrieve or calculate a set of predetermined transmission opportunity limit parameters, each associated with specific bandwidth, and
transmit at least some of the predetermined transmission opportunity limit parameters to a radio device.

11. The apparatus of claim 10, wherein the set of predetermined transmission opportunity limit parameters comprises at least one bandwidth-specific factor for determining a transmission opportunity limit value for at least one secondary channel on the basis of a transmission opportunity limit value for a primary channel.

12. The apparatus of claim 10, wherein the apparatus is a wireless local area network access point and configured to include an information element comprising the at least some of the transmission opportunity limit parameters in an IEEE 802.11 beacon frame or a probe response frame.

13. An apparatus, comprising:
at least one processor; and
at least one memory including computer program code,
the at least one memory and the computer program code configured to, with the at least one processor, cause the apparatus at least to perform:
detect information on available bandwidth for a transmission opportunity applying multiple channels, and
control duration of channel occupancy for at least one of channels available for the transmission opportunity on the basis of the information on available bandwidth.

14. (canceled)

15. The apparatus of claim 13, wherein the apparatus is configured to access a set of predetermined transmission opportunity limit parameters, and
the apparatus is configured to define, for each available secondary channel, a transmission opportunity limit value on the basis of the transmission opportunity limit parameters and the information on available bandwidth.

16. The apparatus of claim 15, wherein the set of predetermined transmission opportunity limit parameters comprises at least one bandwidth-specific factor, and
the apparatus is configured to determine a transmission opportunity limit value for at least one secondary channel on the basis of the factor and a transmission opportunity limit value for a primary channel.

17. The apparatus of claim 15, wherein the apparatus is configured to receive the set of predetermined transmission opportunity limit parameters from another device in at least one of a probe response and a beacon message.

18. The apparatus of claim 15, wherein the apparatus is configured to determine the transmission opportunity limit for each of the secondary channels available for the transmission opportunity on the basis of the set of predetermined transmission opportunity limit parameters and a transmission opportunity limit of the primary channel,
the apparatus is configured to estimate the total duration of channel occupancy during the transmission opportunity, and
the apparatus is configured to ensure for each of the channels that the channel occupancy does not exceed the transmission opportunity limit determined for the channel.

19. The apparatus of claim 18, wherein the apparatus is configured to define the occupancy of the primary channel and the occupancy of at least one secondary channel on the basis of separate timers during the transmission opportunity,
the apparatus is configured to prevent the duration of the primary channel occupancy to exceed the transmission opportunity limit set for the primary channel, and
the apparatus is configured to prevent the duration of the at least one secondary channel occupancy to exceed the transmission opportunity limit set for the at least one secondary channel.

20. The apparatus of claim 13, wherein the apparatus is configured to generate a bandwidth increment factor on the basis of ratio of available bandwidth and the bandwidth of the primary channel, and
the apparatus is configured to calculate a transmission opportunity limit for at least one secondary channel on the basis of a transmission opportunity limit of the primary channel and the bandwidth increment factor.

21. The apparatus of claim 13, wherein the apparatus is configured to calculate expected duration of the transmission opportunity on the basis of the available bandwidth, and
the calculated duration of the transmission opportunity is included in a duration field of a request to send message.

22. The apparatus of claim 13, wherein the apparatus is a communications device comprising a transceiver for communicating according to an IEEE 802.11ac standard, and the channels are IEEE 802.11ac channels.

23. A computer readable storage medium comprising one or more sequences of one or more instructions which, when executed by one or more processors of an apparatus, cause the apparatus to perform: detect, by a communications apparatus, information on available bandwidth for a transmission opportunity applying multiple channels, and
control duration of channel occupancy for at least one of channels available for the transmission opportunity on the basis of the information on available bandwidth.
